(19) United States
(12) Patent Application Publication
(10) Pub. No.: US 2015/0331281 A1
(43) Pub. Date: Nov. 19, 2015

(54) DISPLAY PANEL, DISPLAY DEVICE AND MANUFACTURE METHOD FOR THE DISPLAY PANEL

(71) Applicant: BOE Technology Group Co., Ltd., Beijing (CN)

(72) Inventors: Chen Liu, Beijing (CN); Yue Shi, Beijing (CN)

(21) Appl. No.: 14/497,939

(22) Filed: Sep. 26, 2014

(30) Foreign Application Priority Data
May 13, 2014 (CN) 201410200518.X

(51) Int. Cl. G02F 1/1335

(52) U.S. Cl. CPC G02F 1/133553; G02F 1/133514

(57) ABSTRACT

The present disclosure relates to display technology and provides a display panel. In an embodiment of the present disclosure, the display panel comprises a first substrate and a second substrate assembled with each other, and a liquid crystal layer between the first substrate and the second substrate. The display panel comprises a plurality of pixels distributed in an array manner and each comprising a plurality of sub-pixels. A plurality of color resists being in an one-to-one correspondence with the plurality of sub-pixels and a transparent matrix filled among these adjacent color resists are arranged on a surface of the first substrate facing the liquid crystal layer. A light reflective matrix directly facing the transparent matrix is arranged on a surface of the second substrate facing the liquid crystal layer and has an area greater than that of the transparent matrix in a corresponding position of the first substrate. With the technical solution according to the present disclosure, the brightness of the display panel is increased and thus the display quality is improved. Correspondingly, the present disclosure also provides a display device, and a manufacture method for the display panel.

### CROSS-REFERENCE TO RELATED APPLICATION

This application claims the benefit of Chinese Patent Application No. 201410200518.X filed on May 13, 2014 in the State Intellectual Property Office of China, the whole disclosure of which is incorporated herein by reference.

### BACKGROUND OF THE INVENTION

1. Field of the Invention

The present invention relates to display technology, and more particularly, to a display panel, a display device, and a manufacture method for the display panel.

2. Description of the Related Art

Depending on differences on utilization of the optical source and on the array substrate, liquid crystal display (LCD) is divided into three types, transmissive type, reflective type, and, transflective type. Because of the popularity of the liquid crystal display and the portable electronic product, in order for ensuring display quality of the liquid crystal display, consideration must be given to its use both in outdoor light environment and in indoor light environment, even in a dark environment. Use of a semi-transmissive or reflective liquid crystal display panel ensures the display quality in these environments.

FIG. 1 is a structural schematic diagram of a conventional semi-transmissive or reflective liquid crystal display panel. As shown in FIG. 1, the liquid crystal display panel includes a first substrate 100 and a second substrate 200 assembled with each other, and a liquid crystal layer 300 between the first substrate 100 and the second substrate 200. The display panel comprises a plurality of pixels distributed in an array manner and each comprising a plurality of sub-pixels. FIG. 1 shows one pixel in the display panel. The first substrate 100 mainly comprises a substrate 1100, a color filter layer arranged on the substrate 1100, a flat layer 1400 arranged on the color filter layer, and, a transparent electrode 1500. The color filter layer includes a black matrix (BM) 1300 and a color resist 1200. A reflective film layer 2200 is disposed on the second substrate 200 in correspondence with a portion of each sub-pixel. When used in outdoors, in the display panel under a reflective mode, all the ambient light is absorbed within the region of the black matrix, while, within a reflective area of each sub-pixel, both the incidence and the reflection of the ambient light are through the color filter layer twice, this causes a relatively great optical loss of the ambient light when used in outdoors. In this way, brightness of the entire crystal display panel goes down. Accordingly, when the conventional display panel is used in outdoors, the brightness of the entire crystal display panel is relatively low and thus the display quality is relatively poor.

### SUMMARY OF THE INVENTION

At least one object of embodiments of the present invention is to provide a display panel, the brightness of which is increased and thus the display quality is improved when used in outdoors.

Another object of embodiments of the present invention is to provide a display device, the brightness of which is increased and thus the display quality is improved when used in outdoors.

Still another object of embodiments of the present invention is to provide a manufacture method for a display panel, with which the brightness of the display panel is increased and thus the display quality is improved when used in outdoors.

According to an embodiment of one aspect of the present invention, there is provided a display panel, comprising a first substrate and a second substrate assembled with each other, and a liquid crystal layer between the first substrate and the second substrate, wherein the display panel comprises a plurality of pixels distributed in an array manner and each comprising a plurality of sub-pixels, wherein:
a plurality of color resists being in an one-to-one correspondence with the plurality of sub-pixels and a transparent matrix filled among these adjacent color resists are arranged on a surface of the first substrate facing the liquid crystal layer;
a light reflective matrix directly facing the transparent matrix is arranged on a surface of the second substrate facing the liquid crystal layer and has an area greater than that of the transparent matrix in a corresponding position of the first substrate.

According to an embodiment of another aspect of the present invention, there is provided a display device comprising a backlight module, and the abovementioned display panel arranged on a light emergent side of the backlight module.

According to an embodiment of still another aspect of the present invention, there is provided a manufacture method for a display panel, the method comprising the steps of:
providing a plurality of color resists on a first substrate and being in an one-to-one correspondence with a plurality of sub-pixels of the display panel;
providing a transparent matrix filled among these adjacent color resists;
providing a light reflective matrix directly facing the transparent matrix, on a second substrate, wherein the light reflective matrix has an area greater than that of the transparent matrix in a corresponding position of the first substrate; and
assembling the first substrate with the second substrate.

### BRIEF DESCRIPTION OF THE DRAWINGS

The above and other features of the present invention will become more apparent by describing in detail exemplary embodiments thereof with reference to the accompanying drawings, in which:

FIG. 1 is a structural schematic diagram of a conventional semi-transmissive and semi-reflective liquid crystal display panel;

FIG. 2 is a structural schematic diagram of a display panel according to an embodiment of the present invention;

FIG. 3 is a structural schematic diagram of a display panel according to another embodiment of the present invention;

FIG. 4 is a structural schematic diagram of a display device according to an embodiment of the present invention; and

FIG. 5 is a flow diagram of a manufacture method for a display panel according to an embodiment of the present invention.

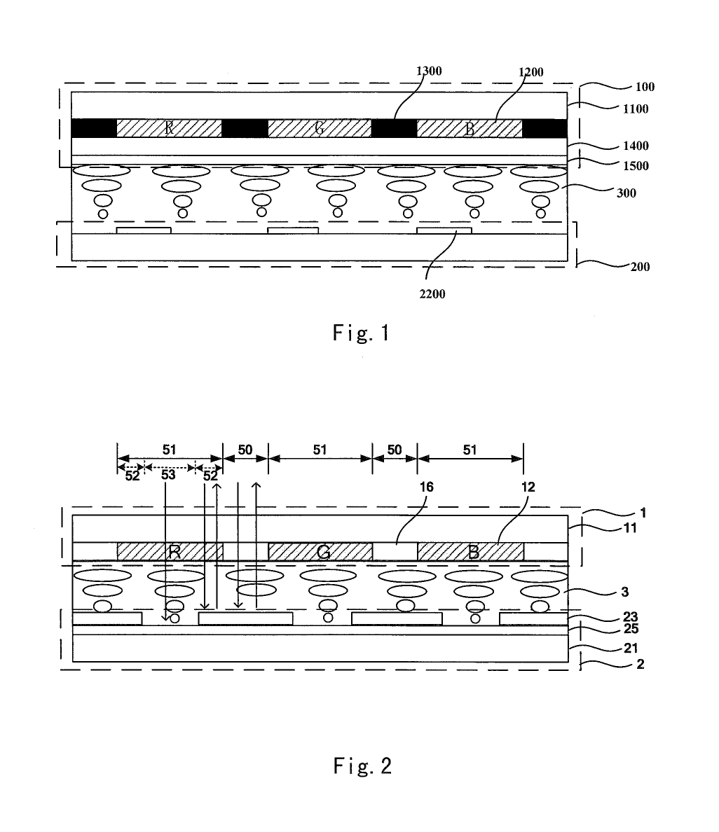

### REFERENCE SIGNS

100—first substrate; 200—second substrate; 300—liquid crystal layer; 1100—substrate; 1200—color resist; 1300—black matrix; 1400—flat layer; 1500—transparent electrode; 2200—reflective film layer; 1—first substrate; 2—second substrate; 3—liquid crystal layer; 4—backlight module; 11—substrate; 12—color resist; 16—transparent matrix; 17—flat layer;

21—array substrate; 23—light reflective matrix; 25—pixel electrode; 26—protective layer; 50—transparent matrix region; 51—sub-pixel region; 52—reflective area; 53—transmissive area

### DETAILED DESCRIPTION OF PREFERRED EMBODIMENTS OF THE INVENTION

Exemplary embodiments of the present invention will be described hereinafter in detail with reference to the attached drawings, wherein the like reference numerals refer to the like elements. The present invention may, however, be embodied in many different forms and should not be construed as being limited to the embodiment set forth herein; rather, these embodiments are provided so that the present invention will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In accordance with a general inventive concept of the present invention, in order to increase brightness of a display panel and thus improve the display quality, a display panel, a display device, and a manufacture method for the display panel are provided in the embodiments of the present invention. Exemplary embodiments of the present invention will be described hereinafter in detail with reference to the attached drawings.

In accordance with the embodiments of the present invention, there provide a display panel. FIG. 2 is a structural schematic diagram of a display panel according to an embodiment of the present invention. As shown in FIG. 2, the display panel comprises a first substrate 1 and a second substrate 2 assembled with each other, and a liquid crystal layer 3 between the first substrate 1 and the second substrate 2. The display panel comprises a plurality of pixels distributed in an array manner and each comprising a plurality of sub-pixels R, G, B.

A plurality of color resists 12 being in an one-to-one correspondence with the plurality of sub-pixels and a transparent matrix 16 filled among these adjacent color resists 12 are arranged on a surface of the first substrate 1 facing the liquid crystal layer 3.

A light reflective matrix 23 directly facing the transparent matrix 16 is arranged on a surface of the second substrate 2 facing the liquid crystal layer 3 and has an area greater than that of the transparent matrix 16 in a corresponding position of the first substrate 1.

In FIG. 2, as shown in the arrowed line, the ambient light emits toward the display panel. In the region 51 of these sub-pixels, within the transmissive area 53, some of the ambient light emits into a position where no light reflective matrix 23 is arranged and to which the color resists 12 correspond, on the second substrate 2, here, no ambient light is reflected. While, within the reflective area 52, some other of the ambient light emits into a position where the light reflective matrix 23 is arranged and to which the color resists 12 correspond, on the second substrate 2, here, the ambient light is reflected. In the non-display region among these sub-pixels, i.e., within the region of the transparent matrix 50, the ambient light emits into the transparent matrix 16 and is reflected by the light reflective matrix 23 arranged on the second substrate 2. Thus it can be seen, in the region of one pixel, only some of the ambient light passes through the color resist 12 twice, and all the ambient light is not absorbed. Accordingly, according to embodiments of the present invention, since the color resists on the sub-pixel are spaced by the transparent matrix 16, when the ambient light passes through the transparent matrix 16, it will be reflected back by the light reflective matrix 23 arranged on the second substrate 2 and into human's eyes, which avoids an optical loss caused by absorption of all the ambient light by the black matrix. In this way, brightness of the display panel is increased and thus the display quality is improved.

Continued to FIG. 2, according to embodiments of the present invention, the first substrate 1 may be a color film substrate where the transparent matrix 16 in place of the black matrix is arranged among the color resists 12. In particular, the first substrate 1 can include a substrate 11, color resists 12 arranged on the substrate 11 and the transparent matrix 16 arranged on the substrate 11. For example, the substrate 11 can be a glass substrate. The second substrate 2 can include an array substrate 21 including thin film transistors (not shown in FIG. 2) distributed in an array manner, etc.

Continued to FIG. 2, in some embodiments, each pixel comprises three sub-pixels, that is, red sub-pixel R, green sub-pixel G and blue sub-pixel B. A width of each sub-pixel is 60-75 microns (that is, a width of the region 51 of the sub-pixel is 60-75 microns) and a spacing distance between two adjacent sub-pixels is 10-15 microns (that is, a width of the transparent matrix 16 filled among the two adjacent sub-pixels is 10-15 microns).

Each pixel may comprise several sub-pixels, e.g., three, four, etc., and preferably, in red, green and blue. A width of each sub-pixel (that is, a width of the region 51 of the sub-pixel) may be 60-75 microns, and, a length of the each sub-pixel will depend on a demand size of the display panel. Preferably, when a width of the sub-pixel is 60-75 microns and a spacing distance between two adjacent sub-pixels is 10-15 microns, brightness of the display panel is greatly increased.

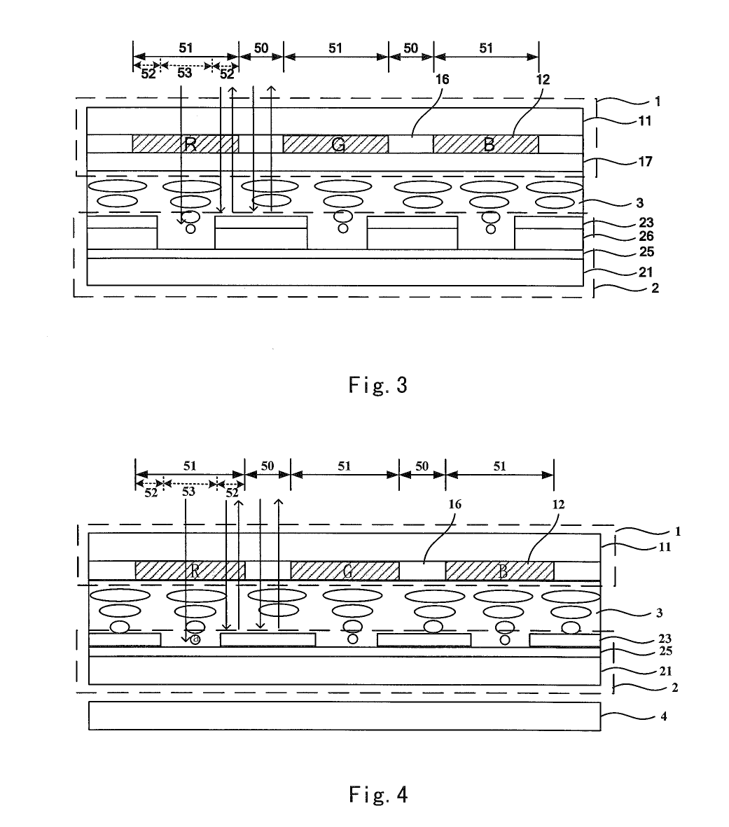

FIG. 3 is a structural schematic diagram of a display panel according to another embodiment of the present invention. As shown in FIG. 3, the display panel further comprises a flat layer 17 arranged on the surface of the first substrate 1 facing the liquid crystal layer 3 and covering over the color resist 12 and the transparent matrix 16.

Continued to FIG. 3, preferably, the flat layer 17 and the transparent matrix 16 are made of the same materials. In this way, the flat layer 17 and the transparent matrix 16 can be made at the same time, thereby reducing manufacture cost.

Referring back to FIG. 2, preferably, each sub-pixel includes a reflective area 52 corresponding to the light reflective matrix and a transmissive area 53 having an area of 40%˜60% of a total area of the sub-pixel. In this way, not only the light leakage is prevented but also the brightness of the display panel is increased.

Referring back to FIG. 3, preferably, the second substrate 2 further comprises a protective layer 26 arranged between a pixel electrode 25 and the light reflective matrix 23 on the second substrate 2.

The protective layer 26 may be made of the material the same as the common flat layer and is used to protect the pixel electrode. Preferably, the protective layer 26 has the same configuration as the light reflective matrix 23 and is below the light reflective matrix 23.

The display panel according to embodiments of the present invention is especially suitable for the semi-transmissive or reflective liquid crystal display panel.

According to these embodiments of the present invention, there also provides a display device. FIG. 4 is a structural schematic diagram of a display device according to an embodiment of the present invention. As shown in FIG. 4, the display device comprises a backlight module 4, and an abovementioned display panel arranged on a light emergent side of the backlight module 4. Any types of the display device can be used, for example, Twisted Nematic (TN) mode, Vertical Alignment (VA) mode, In-Plane-Switching (IPS) mode, Fringe Field Switching (FFS) mode, etc. The display device may include display panel and any products and/or components having a display function, such as, electronic paper, liquid crystal TV, liquid crystal display, digit photo frame, mobile phone, tablet PC, etc.

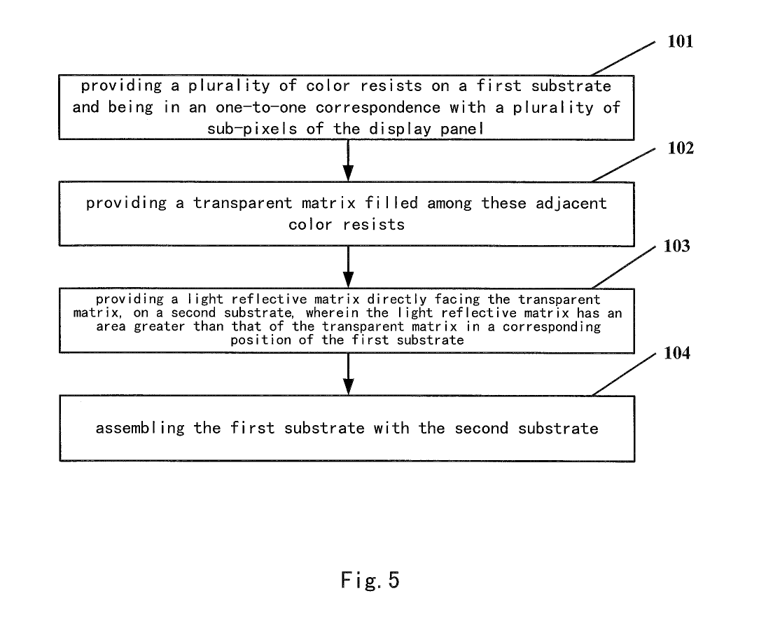

According to these embodiments of the present invention, there also provides a manufacture method for a display panel. FIG. 5 is a flow diagram of a manufacture method for a display panel according to an embodiment of the present invention. As shown in FIG. 5, the method comprises:
step 101 of providing a plurality of color resists on a first substrate and being in an one-to-one correspondence with a plurality of sub-pixels of the display panel;
step 102 of providing a transparent matrix filled among these adjacent color resists;
step 103 of providing a light reflective matrix directly facing the transparent matrix, on a second substrate, wherein the light reflective matrix has an area greater than that of the transparent matrix in a corresponding position of the first substrate; and
step 104 of assembling the first substrate with the second substrate.

Compared with the prior art, in the embodiment of present invention, no black matrix is provided on the first substrate, that is, a step of mask etching is omitted, thereby simplifying the procedure step and greatly reducing the manufacture cost. Of course, there is no sequence requirement for the steps of performing the abovementioned manufacture method for the display panel. For example, the step of manufacturing the first substrate and the step of manufacturing the second substrate can be preformed simultaneously, or, to perform the step of manufacturing the second substrate and then to perform the step of manufacturing the first substrate.

Preferably, after the step of providing the transparent matrix, the method further comprises a step of providing a flat layer covering over the color resist and the transparent matrix.

The flat layer can be manufactured after the manufacture of the transparent matrix. However, preferably, the flat layer and the transparent matrix can be made of same materials simultaneously, e.g., of transparent resin. In this way, the procedure step is simplified and the manufacture cost is reduced.

Preferably, before the step of providing the light reflective matrix, the method further comprises a step of providing a protective layer over the pixel electrode of the second substrate.

A manufacture method for the display panel according to an exemplary embodiment of the present invention will be described hereinafter, although the present invention is not limited to this. However, the manufacture method for the display panel specifically comprises the following steps, as shown in FIG. 3.

To define a region of a transparent matrix 50 and a plurality of regions of pixels on a surface of a first substrate 1, wherein each of the pixels comprises several sub-pixels 51, for example, three-primary colours, red, green and blue. A width of each region 51 of the sub-pixel is 60-75 microns, for example, 60 microns, 65 microns, 70 microns, or 75 microns, while a width between two adjacent regions of the sub-pixels is 10-15 microns, for example, 10 microns, 12 microns, or 15 microns.

To dispose a red light resist R on a region of the red sub-pixel through photolithography, a green light resist G on a region of the green sub-pixel through photolithography, and a blue light resist B on a region of the blue sub-pixel through photolithography.

To coat a transparent resin on the first substrate 1 forming with the color resists to directly form a transparent matrix 16 and a flat layer 17, wherein a width of the transparent matrix 16, that is, the spacing distance between two adjacent regions of the sub-pixels is 10-15 microns.

To dispose a protective layer 26 over a pixel electrode 25 of a second substrate 2 (preferably the array substrate) and then dispose a light reflective matrix 23 over the protective layer 26. The light reflective matrix 23 can be made of metal having optical reflective performance, e.g., by sputtering. The light reflective matrix 23 directly faces the transparent matrix 16 of the first substrate 1. The light reflective matrix 23 has an area greater than the transparent matrix 16, that is, some of the light reflective matrix 23 corresponds to the region of the sub-pixel 51. Accordingly, the region of the sub-pixel 51 is divided correspondingly into a transmissive area 53 and a reflective area 52, wherein the transmissive area 53 has an area of 40%˜60% of a total area of the region of the sub-pixel 51 while the reflective area 52 has an area of 60%˜40% of the total area of the region of the sub-pixel 51. In addition, in order to further ensure the semi-transmissive or reflective performance of the display panel, a total thickness of the protective layer 26 and the light reflective matrix 23 is about a half of the thickness of the entire liquid crystal cell.

To assemble the first substrate 1 with the second substrate 2, after forming a liquid crystal layer 3 between the first substrate 1 and the second substrate 2, e.g., by a dripping method. However, according to embodiments of the present invention, there is no sequence requirement for the step of manufacturing the first substrate 1 and the step of manufacturing the second substrate 2, before the step of assembling.

With the present invention, by the steps of directly forming a plurality of color resists on the first substrate, and then, of directly forming the transparent matrix and the flat layer, a procedure step for the black matrix, that is, a photolithography step, is omitted, thereby simplifying the procedure process and reducing the manufacture cost. Furthermore, since these sub-pixels are spaced by the transparent matrix, when the ambient light passes through the transparent matrix 16, it will be reflected back by the light reflective matrix 23 arranged on the second substrate 2 and into human's eyes, which avoids an optical loss caused by absorption of all the ambient light by the black matrix. In this way, brightness of the entire display panel is increased and thus the display quality is improved.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

What is claimed is:

1. A display panel, comprising a first substrate and a second substrate assembled with each other, and a liquid crystal layer between the first substrate and the second substrate, wherein the display panel comprises a plurality of pixels distributed in an array manner and each comprising a plurality of sub-pixels, wherein:
a plurality of color resists being in an one-to-one correspondence with the plurality of sub-pixels and a transparent matrix filled among these adjacent color resists are arranged on a surface of the first substrate facing the liquid crystal layer;
a light reflective matrix directly facing the transparent matrix is arranged on a surface of the second substrate facing the liquid crystal layer and has an area greater than that of the transparent matrix in a corresponding position of the first substrate.

2. The display panel according to claim 1, wherein each of the pixels comprises three sub-pixels, respectively being a red sub-pixel, a green sub-pixel and a blue sub-pixel, wherein a width of each of the sub-pixels is 60-75 microns and a spacing distance between two adjacent ones of the sub-pixels is 10-15 microns.

3. The display panel according to claim 1, further comprising a flat layer arranged on the surface of the first substrate facing the liquid crystal layer and covering over the color resist and the transparent matrix.

4. The display panel according to claim 2, further comprising a flat layer arranged on the surface of the first substrate facing the liquid crystal layer and covering over the color resist and the transparent matrix.

5. The display panel according to claim 3, wherein the flat layer and the transparent matrix are made of the same material.

6. The display panel according to claim 4, wherein the flat layer and the transparent matrix are made of the same material.

7. The display panel according to claim 1, wherein each of the sub-pixels comprises a reflective area corresponding to the light reflective matrix, and a transmissive area having an area of 40%˜60% of a total area of the sub-pixel.

8. The display panel according to claim 6, wherein each of the sub-pixels comprises a reflective area corresponding to the light reflective matrix, and a transmissive area having an area of 40%˜60% of a total area of the sub-pixel.

9. The display panel according to claim 1, wherein the second substrate further comprises a protective layer arranged between a pixel electrode and the light reflective matrix of the second substrate.

10. The display panel according to claim 8, wherein the second substrate further comprises a protective layer arranged between a pixel electrode and the light reflective matrix of the second substrate.

11. A display device comprising a backlight module, and a display panel according to claim 1 arranged on a light emergent side of the backlight module.

12. A display device comprising a backlight module, and a display panel according to claim 10 arranged on a light emergent side of the backlight module.

13. A manufacture method for a display panel, the method comprising the steps of:
providing a plurality of color resists on a first substrate and being in an one-to-one correspondence with a plurality of sub-pixels of the display panel;
providing a transparent matrix filled among these adjacent color resists;
providing a light reflective matrix directly facing the transparent matrix, on a second substrate, wherein the light reflective matrix has an area greater than that of the transparent matrix in a corresponding position of the first substrate; and
assembling the first substrate with the second substrate.

14. The manufacture method according to claim 13, further comprising, after the step of providing the transparent matrix, a step of providing a flat layer covering over the color resist and the transparent matrix.

15. The manufacture method according to claim 13, further comprising, before the step of providing the light reflective matrix, a step of providing a protective layer over a pixel electrode of the second substrate.
